(19) United States
(12) Patent Application Publication
(10) Pub. No.: US 2026/0292616 A1
(43) Pub. Date: Sep. 24, 2026

(54) NW SIGNALLING AND UE BEHAVIOR FOR TRUNCATED PBCH IN LESS THAN 5MHZ

(71) Applicant: MEDIATEK SINGAPORE PTE. LTD., Singapore (SG)

(72) Inventors: Waseem Hazim Ozan OZAN, Cambridge (GB); Timothy James FROST, Oulu (FI); Tsang-Wei YU, Hsinchu City (TW)

(73) Assignee: MEDIATEK SINGAPORE PTE. LTD., Singapore (SG)

(21) Appl. No.: 19/474,235

(22) PCT Filed: Aug. 13, 2024
(86) PCT No.: PCT/CN2024/111668

§ 371 Date: Oct. 10, 2025

Related U.S. Application Data
(60) Provisional application No. 63/519,287, filed on Aug. 14, 2023.

(51) Int. Cl. H04W 36/00; H04W 36/08; H04W 56/00

(52) U.S. Cl. CPC H04W 36/0072; H04W 36/0058; H04W 36/08; H04W 56/001

(57) ABSTRACT

In an aspect of the disclosure, a method, a computer-readable medium, and an apparatus are provided. The apparatus may be a UE. The UE receives a synchronization signal block (SSB) and a configuration signaling comprising an indicator indicating a type of the SSB from a base station. The UE determines, based on the configuration signaling, the type of the SSB. The UE determines, based on the type of the SSB, a behavior corresponding to a particular scenario.

### CROSS-REFERENCE TO RELATED APPLICATION(S)

This application claims the benefits of U.S. Provisional Application Ser. No. 63/519,287, entitled “LESS THAN 5 MHZ IMPACT ON SBI” and filed on Aug. 14, 2023, which is expressly incorporated by reference herein in their entirety.

### BACKGROUND

### Field

The present disclosure relates generally to wireless communications, and more particularly, to techniques for handling truncated physical broadcast channel (PBCH) in wireless communication systems.

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives a synchronization signal block (SSB) and a configuration signaling comprising an indicator indicating a type of the SSB from a base station. The UE determines, based on the configuration signaling, the type of the SSB. The UE determines, based on the type of the SSB, a behavior corresponding to a particular scenario.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating a scenario where a UE needs to perform measurements on neighboring cells for potential handover or cell reselection.

FIG. 8(A) is a diagram depicting a full SSB.

FIG. 8(B) is a diagram depicting a truncated SSB.

FIG. 9(A) illustrates a flow chart of a process for handling different SSB types at the UE side.

FIG. 9(B) illustrates a flow chart of a process for handling different SSB types at the network side.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

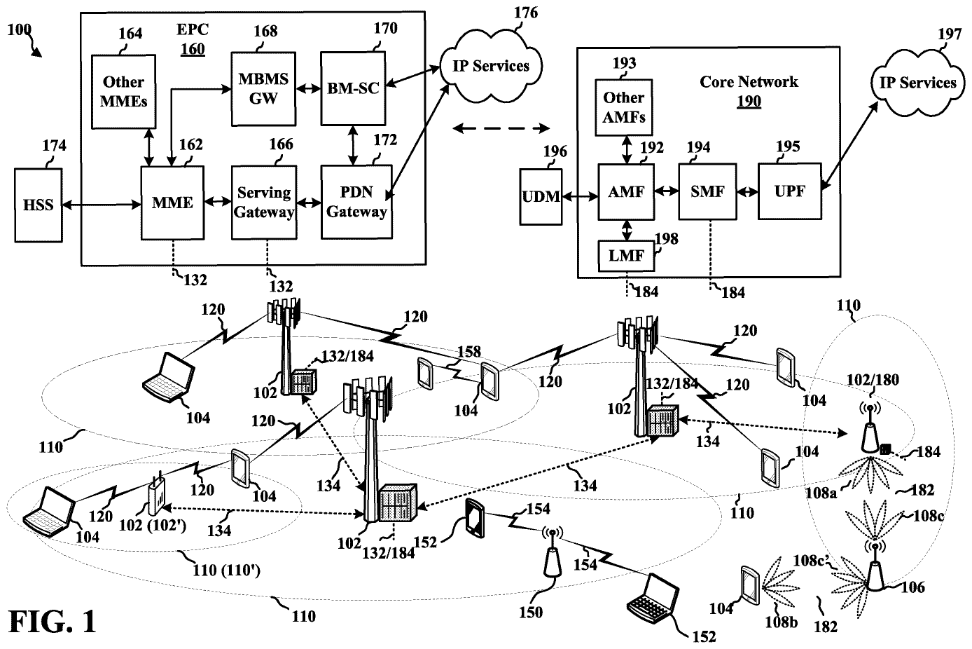

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

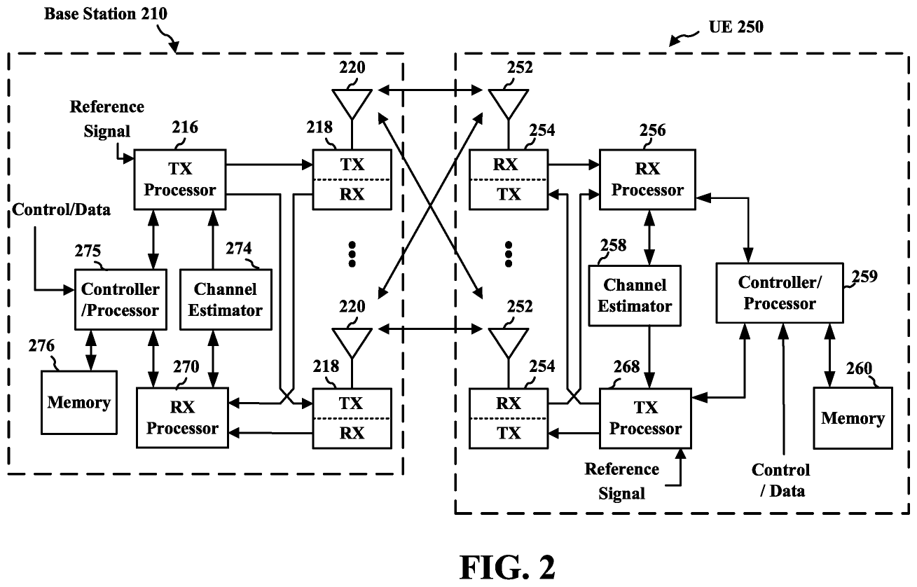

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

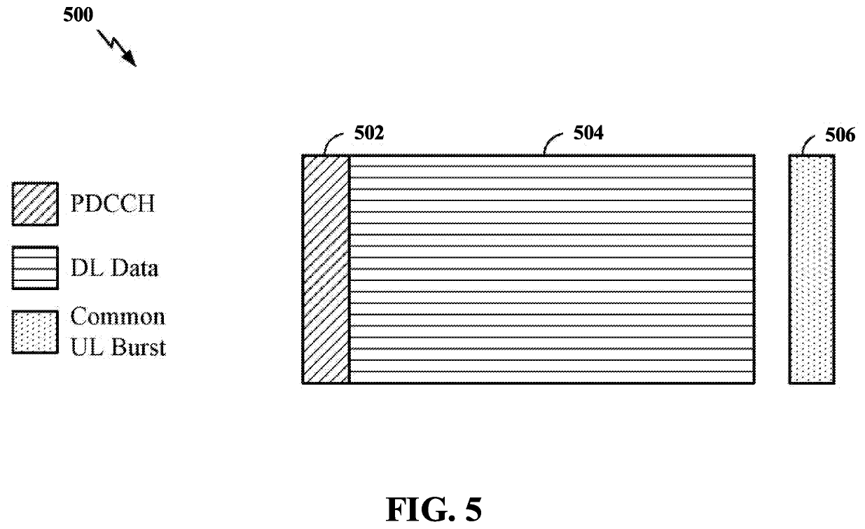

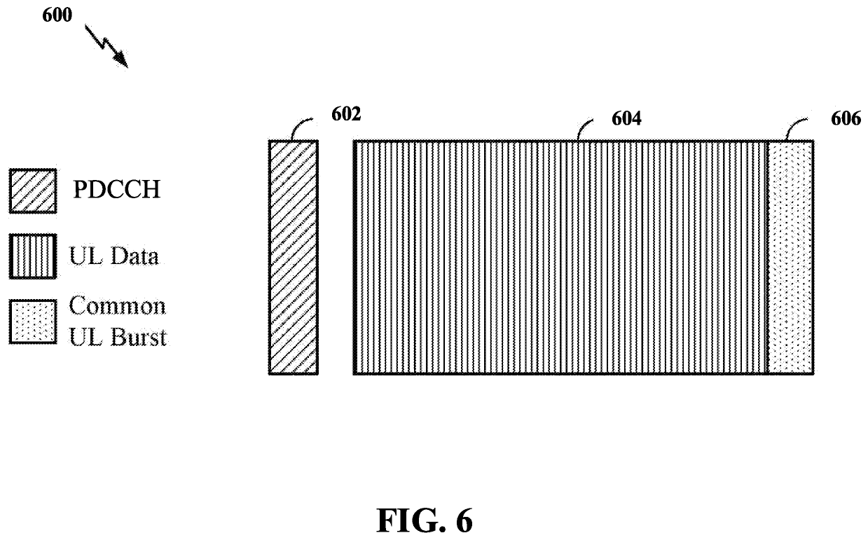

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

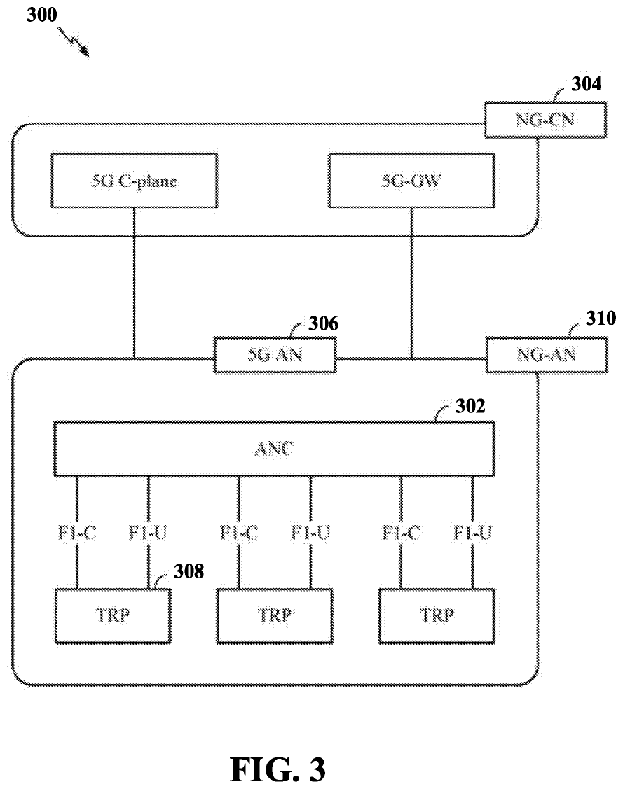

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

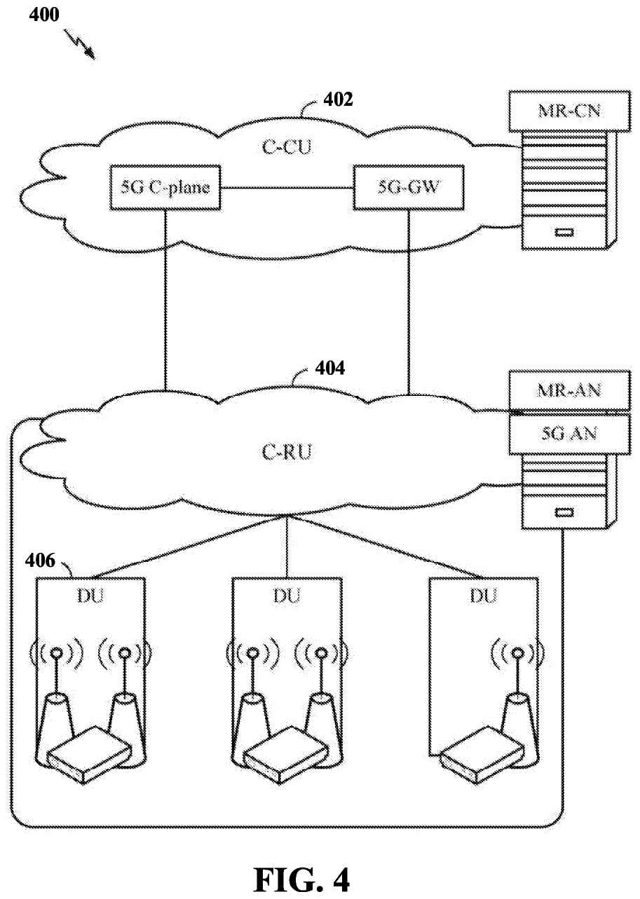

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

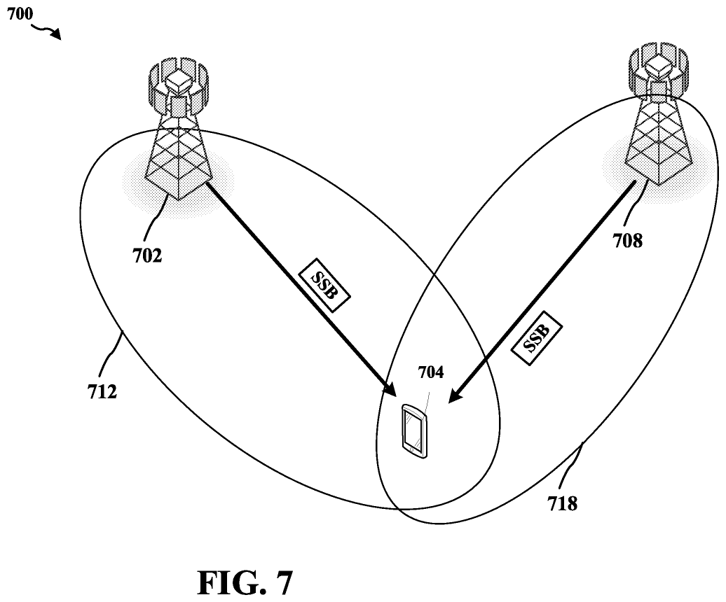

FIG. 7 is a diagram 700 illustrating a scenario where a UE needs to perform measurements on neighboring cells for potential handover or cell reselection. In this example, a UE 704 is connected to a base station 702 on a cell 712. The UE 704 is also within the coverage of a neighboring cell 718 of a base station 708.

Implementation of truncated Physical Broadcast Channel (PBCH) or truncated Synchronization Signal Block (SSB) in 5G New Radio (NR) systems operating in bandwidths less than 5 MHz may introduce certain challenges. For example, the base station 708 of the neighboring cell 718 may be transmitting a truncated SSB, which the UE 704 needs to measure and decode.

Traditionally, the SSB has a fixed size of 20 Physical Resource Blocks (PRBs) in frequency and 4 OFDM symbols in time. However, with the introduction of truncated PBCH, the SSB may have fewer PRBs, particularly in the PBCH portion. This truncation poses several challenges for the UE 704 when performing measurements on the neighboring cell 718: 1. The UE 704 may not know whether the SSB from the base station 708 is truncated or full-sized. 2. The UE 704 may need to adapt its behavior for measuring and decoding the truncated SSB. 3. The serving base station 702 may need a mechanism to inform the UE 704 about the presence of truncated SSBs in neighboring cells.

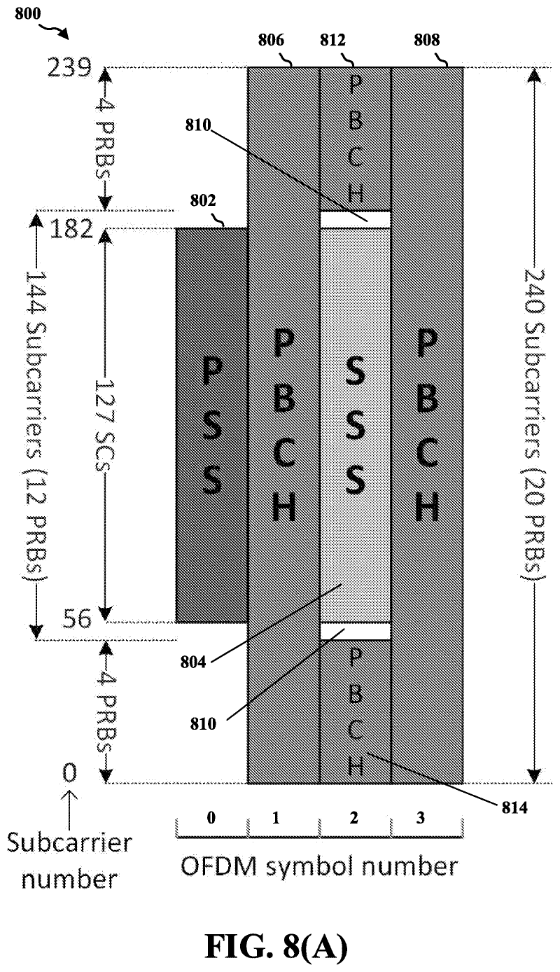

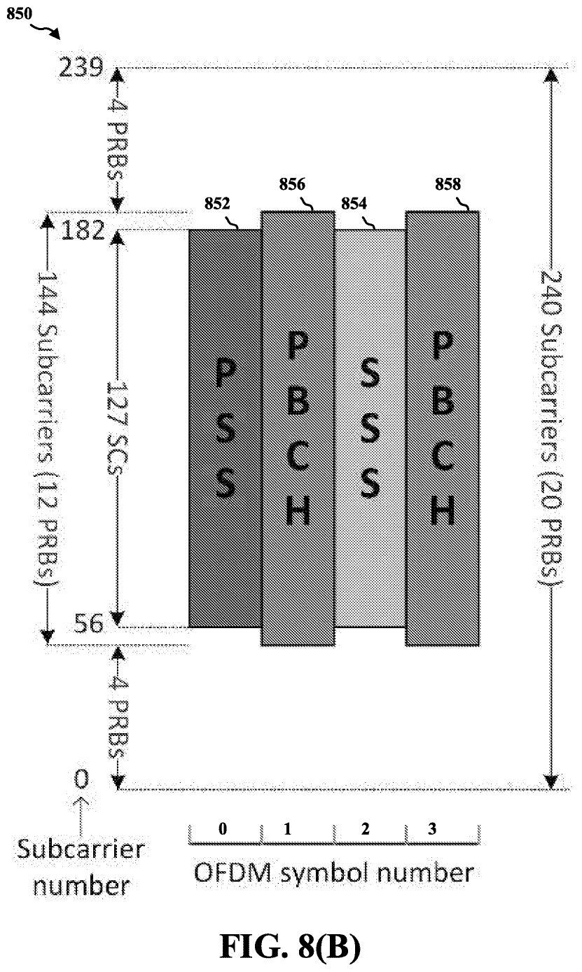

FIG. 8(A) is a diagram illustrating the structure of a full Synchronization Signal Block (SSB) 800 in 5G New Radio (NR) systems. In 5G NR, the SSB 800 occupies 20 Physical Resource Blocks (PRBs) in the frequency domain and 4 Orthogonal Frequency Division Multiplexing (OFDM) symbols in the time domain. This configuration is considered the full-sized SSB, which is traditionally used in bandwidths of 5 MHz and above.

The SSB comprises several key components, each serving a specific purpose in the synchronization and initial access procedures. The Primary Synchronization Signal (PSS) 802 is located in the first OFDM symbol (symbol 0) of the SSB. The PSS 802, along with its associated guard bands 810, occupies approximately 12 PRBs in the center of the frequency range.

In the second OFDM symbol (symbol 1), there is a first instance of the Physical Broadcast Channel (PBCH) 806. The PBCH 806 spans the entire 20 PRB bandwidth of the SSB, extending both above and below the frequency range occupied by the PSS 802.

The third OFDM symbol (symbol 2) contains the Secondary Synchronization Signal (SSS) 804. Similar to the PSS 802, the SSS 804 and its guard bands 810 occupy about 12 PRBs in the center of the frequency range.

The fourth and final OFDM symbol (symbol 3) of the SSB contains a second instance of the PBCH 808. Like the first instance, this PBCH 808 also spans the full 20 PRB bandwidth of the SSB.

The PBCH portions (806, 808, 812, 814) of the SSB extend beyond the bandwidth occupied by the PSS 802 and SSS 804. This full utilization of the 20 PRB bandwidth by the PBCH is a characteristic of the full-sized SSB.

FIG. 8(B) is a diagram 800 illustrating a truncated SSB 850. In scenarios where network bandwidth is limited, particularly in deployments with less than 5 MHz of bandwidth, the entire SSB data cannot be transmitted over the network. In these cases, truncation of the SSB data occurs, resulting in a truncated SSB 850.

In the truncated SSB 850, a PSS 852 remains similar to the PSS 802 shown in FIG. 8(A), occupying approximately 12 Physical Resource Blocks (PRBs) in the center of the frequency range, including its associated guard bands. An SSS 854 is positioned in the third OFDM symbol (symbol 2), also occupying about 12 PRBs in the center of the frequency range, similar to the SSS 804 in FIG. 8(A).

However, the PBCH portions of the truncated SSB 850 are significantly modified compared to the full SSB 800. The PBCHs occupying frequency bands extending both above and below the frequency range covered by the SSS 854 are removed. The two individual PBCH instances (856, 858), located in symbols 1 and 3 respectively, are truncated compared to the PBCHs (806, 808) shown in FIG. 8(A). Both the upper and lower portions of PBCHs (856, 858) in frequency positions that fall outside the frequency range covered by the SSS 854 are truncated, retaining only the middle portion.

Further, in the present disclosure, the term ‘truncated SSB’ may be used interchangeably used with ‘truncated PBCH’, which, within the truncated SSB, occupies less than 20 PRBs. The ‘truncated PBCH’ is a PBCH after being punctured. Therefore, the term ‘truncated SSB’ may be used interchangeably used with ‘SS/PBCH block after puncturing’, where the PBCH transmission bandwidth after puncturing occupies 12 PRBs (856, 858) shown in FIG. 8(B). This reduction in PRB utilization is a characteristic of the truncated SSB 850, distinguishing it from the full SSB 800.

The truncated SSB 850 is introduced to accommodate diverse network deployment requirements, particularly in bandwidth-constrained scenarios. By utilizing a reduced set of PRBs for transmitting the SSB, the network can minimize the bandwidth occupied by the SSB without compromising the transmission of critical synchronization and broadcast information.

Traditionally, when the network configures a UE 704 with configuration signaling, which may be Radio Resource Control (RRC) signaling, it specifies which SSB to measure without necessarily indicating the SSB's bandwidth. Given that the SSB has traditionally been of a fixed size in terms of the number of PRBs and OFDM symbols, implying a consistent bandwidth, the UE 704 typically performs a standard measurement procedure to read the information carried in the PBCH and PSS/SSS.

However, the introduction of the truncated SSB 850 with a reduced bandwidth, transmitting fewer PRBs compared to the full SSB 800, necessitates that the UE 704 adapt its handling of the truncated SSB 850 accordingly. Specifically, based on the SSB type (whether full or truncated), the UE 704 needs to adopt different approaches for measurement and decoding.

This adaptation introduces several challenges for the UE 704 when performing measurements on neighboring cells, such as the cell 718 of the base station 708. Firstly, the UE 704 may not know whether the SSB from the base station 708 is truncated or full-sized. Secondly, the UE 704 needs to adjust its behavior for measuring and decoding the truncated SSB. Lastly, the serving base station 702 requires a mechanism to inform the UE 704 about the presence of truncated SSBs in neighboring cells.

To address these challenges, several proposals are put forward. When the UE 704 is measuring neighboring cells with a truncated PBCH, its behavior should differ from that used for full PBCH in the SSB. This may involve longer evaluation periods, increased latency, or following different requirements for the existing SSB and the truncated PBCH of the new SSB.

Furthermore, when performing SSB Block Index (SBI) reading, the UE 704 should consider the truncated PBCH within the truncated SSB. This may require the use of one or multiple truncated SSBs to read the SBI accurately. The UE 704 may also need to employ soft-combining techniques to decode the truncated PBCH using either one or multiple truncated SSBs.

For Radio Resource Management (RRM) measurements, the UE 704 may utilize the truncated PBCH of the truncated SSB to complete Layer 1 and Layer 3 measurements such as Reference Signal Received Power (RSRP), Reference Signal Received Quality (RSRQ), and Signal-to-Interference-plus-Noise Ratio (SINR).

To facilitate these adaptations, it is proposed that the network configure the UE 704 with information indicating whether the PBCH within an SSB is truncated or not. This configuration could be provided through Measurement Object (MO) signaling, handover commands, or other RRC signaling mechanisms. The UE 704 would then be responsible for identifying whether the configured PBCH is full or truncated based on this information.

By implementing these proposals, the network and UE can effectively handle the challenges introduced by truncated SSBs in bandwidth-constrained scenarios, enabling efficient cell measurements and handovers in 5G NR systems operating in bandwidths less than 5 MHz.

More specifically, to address these challenges, several proposals may be utilized by the UE 704 to modify the behavior of the UE 704 when dealing with truncated Physical Broadcast Channels (PBCHs) within SSBs. These proposals aim to improve the accuracy and efficiency of measurements performed by the UE 704 in scenarios involving truncated SSBs.

In a first proposal, when the UE 704 is measuring neighboring cells with a truncated PBCH (i.e., where the PBCH occupies less than 20 Physical Resource Blocks or PRBs), its behavior may differ from that used when measuring cells with full PBCHs. This differentiation is necessary because the truncated PBCH contains less information and may require different processing techniques to extract the required data accurately.

The UE 704 may need to adapt its measurement procedures to account for the reduced bandwidth of the truncated PBCH. This adaptation could involve adjusting the measurement window, modifying the sampling rate, or employing different algorithms for signal processing. The specific behavioral changes would depend on the exact nature of the truncation and the information available to the UE 704 about the truncated SSB structure.

The second proposal focuses on the SSB Block Index (SBI) reading process when dealing with truncated PBCHs. In this proposal, the UE 704 may perform SBI reading while considering the reduced bandwidth of the truncated PBCH. The SBI may help the UE 704 locate and decode specific PBCH information, enabling it to obtain essential system information.

When reading the SBI from a truncated PBCH, the UE 704 may need to employ different decoding techniques or use multiple truncated SSBs to accurately extract the SBI information. This could involve using soft-combining techniques to aggregate information from multiple truncated PBCHs, thereby improving the reliability of the SBI reading process.

The third proposal addresses the handover scenario involving cells with truncated PBCHs. In this proposal, when the UE 704 is performing a handover to a cell using a truncated PBCH, its behavior should differ from that used when handling full PBCHs. This differentiation is necessary because the handover process relies heavily on the information contained within the PBCH, and a truncated PBCH may not provide all the information typically available in a full PBCH.

The UE 704 may need to adapt its handover procedures to account for the limited information available in the truncated PBCH. This could involve requesting additional information from the serving cell, using different criteria for handover decisions, or employing alternative methods to verify the suitability of the target cell for handover.

The fourth proposal relates to Radio Resource Management (RRM) measurements when dealing with truncated PBCHs. In this proposal, the UE 704 may have the option to measure or not measure the truncated PBCH during RRM measurements. This flexibility allows the UE 704 to adapt its measurement strategy based on the specific circumstances and the quality of the received signal.

In scenarios where the truncated PBCH provides sufficient information for RRM measurements, the UE 704 may choose to include it in its measurements. However, in cases where the truncated PBCH does not contribute significantly to the accuracy of RRM measurements or where measuring it may introduce unnecessary complexity, the UE 704 may opt to exclude it from its measurements.

To facilitate these adaptive behaviors, it is proposed that the network should configure the UE 704 with information indicating whether the PBCH within an SSB is truncated or not. This configuration could be provided through various signaling mechanisms, such as Measurement Object (MO) signaling, handover commands, or other Radio Resource Control (RRC) signaling.

The MO signaling typically informs the UE 704 about which neighboring cells to measure. By including information about the truncation status of the PBCH in these cells, the network can enable the UE 704 to adjust its measurement behavior accordingly. Similarly, including this information in handover commands can help the UE 704 prepare for the appropriate handover procedures based on whether the target cell uses a truncated or full PBCH.

The above proposals address scenarios where the UE 704 is already connected to a serving cell and is performing measurements on neighboring cells. The initial access scenario, where the UE 704 first joins or attaches to a cell, is handled differently. During initial access, the synchronization raster (sync raster) mechanism is used to indicate the location of truncated SSBs in the frequency domain, allowing the UE 704 to adapt its behavior accordingly.

A fifth proposal involves the network's ability to configure the UE 704 with a list of cells or carriers (e.g., N cells or carriers) that utilize truncated PBCHs. This configuration mechanism allows the network to provide the UE 704 with information about the structure of SSBs in neighboring cells. By informing the UE 704 about which cells employ truncated PBCHs, the network enables the UE 704 to adapt its measurement and decoding strategies accordingly.

The network may implement this configuration through various signaling mechanisms, such as Measurement Object (MO) signaling, handover commands, or other Radio Resource Control (RRC) signaling. For instance, when configuring a Measurement Object for the UE 704, the network can include an indicator or a specific field that denotes whether the PBCH within the SSB of a particular cell is truncated or full-sized. This information is particularly useful when the network instructs the UE 704 to measure neighboring cells, as it allows the UE 704 to anticipate the structure of the SSB it will encounter.

Furthermore, in a sixth proposal, the network can extend its configuration capabilities to influence the UE's behavior during Radio Resource Management (RRM) measurements. Specifically, the network may instruct the UE 704 not to decode the PBCH during RRM measurements for certain cells on the list of cells with truncated PBCHs. Instead, the UE 704 would be directed to focus solely on decoding the PSS and SSS.

This selective decoding approach can be beneficial when dealing with legacy UEs that may not be fully equipped to handle truncated PBCHs efficiently. By instructing these legacy devices to concentrate on the PSS and SSS, which remain largely unchanged in the truncated SSB structure, the network can still obtain valuable measurement data while avoiding potential complications arising from the truncated PBCH.

A seventh proposal relates to cell reselection scenarios. When a UE 704 decides to reselect to a target cell, it is proposed that the UE 704 should read the truncated PBCH of the target cell. The UE 704 obtains the necessary system information from the truncated PBCH before completing the cell reselection process.

To facilitate this, the network may need to provide additional guidance or parameters to the UE 704 regarding how to interpret and process the truncated PBCH during cell reselection. This could involve specifying the location of critical information within the truncated PBCH or providing instructions on how to combine information from multiple truncated SSBs if necessary.

In various embodiments, the UE 704 may exhibit different behaviors when dealing with truncated Physical Broadcast Channels (PBCHs) within Synchronization Signal Blocks (SSBs). These behavioral adaptations may accommodate the reduced information content in truncated PBCHs while maintaining measurement accuracy and efficiency.

One aspect of the UE's behavior relates to the evaluation period and latency associated with measuring truncated SSBs. Typically, the UE 704 is required to meet specific performance criteria by measuring a predetermined number of SSBs (e.g., X SSBs) within a normal evaluation period. However, when dealing with truncated SSBs, the UE 704 may need to extend this evaluation period to maintain the same level of accuracy. For instance, the UE 704 might be instructed to measure X+2 or X+3 SSBs, effectively increasing the number of samples to compensate for the reduced information in each truncated SSB.

This extended evaluation period naturally leads to increased latency in the measurement process. Latency, in this context, can be understood as the delay required to complete cell detection or, more precisely, as the measurement delay. The relationship between evaluation period, latency, and measurement accuracy can be conceptualized as a triangle, where trade-offs exist between these three factors. For example, if the UE 704 maintains the normal evaluation period when measuring truncated SSBs, it may complete the process more quickly but potentially at the cost of reduced accuracy. Conversely, opting for a longer evaluation period can enhance accuracy but at the expense of increased latency.

Another aspect of the UE's behavior concerns its ability to read the SSB Block Index (SBI) from truncated PBCHs. The truncation process inevitably results in the loss of some information, as certain portions of the PBCH are not transmitted. Referring to FIG. 8(A) and FIG. 8(B), PBCHs 812, 814 and the upper and lower portions of PBCHs 856, 858 are not transmitted in the truncated SSB 850. Consequently, the UE 704 must employ more advanced decoding techniques to successfully extract the SBI from this reduced information set.

To address this challenge, the UE 704 may utilize one or multiple truncated SSBs to read the SBI accurately. This approach allows the UE 704 to aggregate information from multiple instances of the truncated PBCH, potentially recovering the lost data through redundancy and error correction mechanisms. The UE 704 may also employ sophisticated decoding algorithms capable of extracting the necessary information from the truncated PBCH, even with the reduced data set.

In ideal conditions with minimal noise and excellent channel quality, the UE 704 should theoretically be able to decode the truncated PBCH and extract the SBI from a single instance. However, real-world conditions often necessitate the use of multiple SSBs due to noise, interference, and suboptimal channel conditions. This requirement stems from the underlying principles of channel coding and interleaving employed in the transmission process.

Channel coding and interleaving techniques involve replicating and dispersing data bits to enhance robustness against errors. When truncation occurs, some of these replicated bits are lost, potentially degrading overall performance. However, if the Signal-to-Interference-plus-Noise Ratio (SINR) is sufficiently high, the UE 704 can still successfully decode the data and extract the SBI, albeit with potentially reduced efficiency compared to decoding a full PBCH.

To further improve decoding performance, the UE 704 may employ soft-combining techniques when processing multiple truncated PBCHs. Soft-combining is a method that enhances the decoding process by intelligently fusing information from multiple signal instances. One example of a soft-combining technique is the use of Log-Likelihood Ratios (LLRs), which represent soft values that can be iteratively refined during the channel decoding process.

The advantage of soft-combining lies in its ability to work with soft bits, which embody the decoder's probabilistic evaluation of each transmitted bit, rather than relying solely on hard decisions. In the soft-combining process, these soft bits, typically expressed as LLRs, are consolidated from various truncated PBCH receptions. This consolidation can be achieved through diverse algorithms, such as Maximum Ratio Combining (MRC), which assigns weights to contributions based on signal quality, or Equal Gain Combining (EGC), which treats all signals equally.

The aggregated LLRs yield a more robust estimation of the transmitted bits, effectively mitigating the effects of noise and interference. By employing soft-combining techniques, the UE 704 can more reliably decode truncated PBCH signals, thereby improving its ability to extract critical system information even under adverse conditions.

In addition to SBI extraction and decoding, the UE 704 may also adapt its behavior when performing various measurements on truncated SSBs. These measurements may include Layer 1 Reference Signal Received Power (L1-RSRP), Layer 3 Reference Signal Received Power (L3-RSRP), Reference Signal Received Quality (RSRQ), and Signal-to-Interference-plus-Noise Ratio (SINR). When conducting these measurements, the UE 704 shall utilize the truncated PBCH of the truncated SSB to complete the measurements accurately.

The truncated SSB contains less information than a full SSB. The UE 704, therefore, adjusts its measurement algorithms and processing techniques to extract meaningful and accurate measurement results from the reduced data set. This may involve modifying the measurement window, adjusting the sampling rate, or employing different signal processing algorithms optimized for truncated SSBs.

Furthermore, the UE 704 needs to be aware of the truncated nature of the SSB it is measuring. This awareness can be facilitated through network signaling mechanisms, such as Measurement Object (MO) signaling or handover commands. By receiving information about the truncated status of SSBs in neighboring cells, the UE 704 can preemptively adapt its measurement and decoding strategies to optimize performance.

In scenarios where the network configures the UE 704 with a list of cells or carriers utilizing truncated PBCHs, the UE 704 is capable of managing and applying different measurement and decoding strategies for each cell based on its SSB configuration. This flexibility allows the UE 704 to efficiently handle a mix of cells with full and truncated SSBs in its vicinity.

Moreover, the UE 704 should be prepared to handle scenarios where the network instructs it not to decode the PBCH during Radio Resource Management (RRM) measurements for certain cells with truncated PBCHs. In such cases, the UE 704 would focus solely on decoding the Primary Synchronization Signal (PSS) and Secondary Synchronization Signal (SSS), adapting its measurement procedures accordingly.

Lastly, in cell reselection scenarios, the UE 704 must be capable of reading and interpreting the truncated PBCH of the target cell. This involves extracting the necessary system information from the truncated PBCH to facilitate a smooth cell reselection process. The UE 704 may need to apply specialized decoding techniques or combine information from multiple truncated SSBs to obtain a complete set of required system information for cell reselection.

In various embodiments, the network (NW) facilitates the UE's handling of truncated Physical Broadcast Channels (PBCHs) within Synchronization Signal Blocks (SSBs). The NW implements several mechanisms to inform the UE 704 about the presence and characteristics of truncated PBCHs in neighboring cells, enabling the UE 704 to adapt its measurement and decoding strategies accordingly.

One aspect of the NW's functionality involves configuring the UE 704 with information indicating whether the PBCH within an SSB is truncated or not. This configuration can be achieved through various signaling mechanisms, including Measurement Object (MO) signaling, handover commands, or other Radio Resource Control (RRC) signaling.

Measurement Objects (MOs) are parameters configured by the NW to guide the UE 704 on how to perform measurements. These parameters may include the types of signals to be measured (such as Reference Signal Received Power (RSRP), Reference Signal Received Quality (RSRQ), Signal-to-Interference-plus-Noise Ratio (SINR), etc.), frequencies, cell IDs, measurement periods, and other relevant information. MOs assist the UE 704 in assessing its current network environment and signal quality, thereby supporting network selection, cell re-selection, and handover decisions. For example, in a 5G network, the UE 704 can measure the signal quality on different frequency points based on the MOs configured by the NW and select the optimal serving cell based on the measurement results.

Handover (HO) parameters or commands encompass instructions that inform the UE 704 when and how to switch from one serving cell to another. These parameters or commands may include the identity of the target cell, signal quality thresholds required for handover, handover preparation time, resource allocation information, and other relevant data. The role of HO parameters or commands is to optimize network performance and resource utilization while maintaining service continuity. Through precise handover control, the NW can reduce call drop rates, increase data transmission rates, and lower latency.

In the MO or HO signaling, the NW may incorporate an indicator to specify whether the PBCH is truncated or complete. This indicator allows the UE 704 to determine whether the SSB to be measured is 3 MHz or 5 MHz, effectively identifying whether the configured SSB is a full SSB or a truncated SSB. For instance, when configuring a Measurement Object for the UE 704, the NW may include an indicator or a specific field that denotes whether the PBCH within the SSB of a particular cell is truncated or full-sized.

As described supra, the NW may configure the UE 704 with a list of cells or carriers (e.g., N cells or carriers) that utilize truncated PBCHs. This configuration mechanism allows the NW to provide the UE 704 with comprehensive information about the structure of SSBs in neighboring cells. By informing the UE 704 about which cells employ truncated PBCHs, the NW enables the UE 704 to adapt its measurement and decoding strategies accordingly for each cell in its vicinity.

Furthermore, the NW may extend its configuration capabilities to influence the UE's behavior during Radio Resource Management (RRM) measurements. Specifically, the NW may instruct the UE 704 not to decode the PBCH during RRM measurements for certain cells on the list of cells with truncated PBCHs. Instead, the UE 704 would be directed to focus solely on decoding the Primary Synchronization Signal (PSS) and Secondary Synchronization Signal (SSS). This selective decoding approach can be beneficial when dealing with legacy UEs that may not be fully equipped to handle truncated PBCHs efficiently. By instructing these legacy devices to concentrate on the PSS and SSS, which remain largely unchanged in the truncated SSB structure, the NW can still obtain valuable measurement data while avoiding potential complications arising from the truncated PBCH.

While Measurement Objects and handover commands are common examples of such signaling, the NW may employ other forms of RRC signaling to convey information about truncated PBCHs. This flexibility allows the NW to adapt its signaling approach based on the specific requirements of different network deployments and UE capabilities.

In scenarios involving cell reselection, the NW may provide additional guidance or parameters to the UE 704 regarding how to interpret and process the truncated PBCH during the reselection process. This could involve specifying the location of critical information within the truncated PBCH or providing instructions on how to combine information from multiple truncated SSBs if necessary.

The NW's role in managing truncated PBCHs extends beyond mere signaling. It may also coordinate the transmission of truncated SSBs across multiple cells to minimize interference and optimize overall network performance.

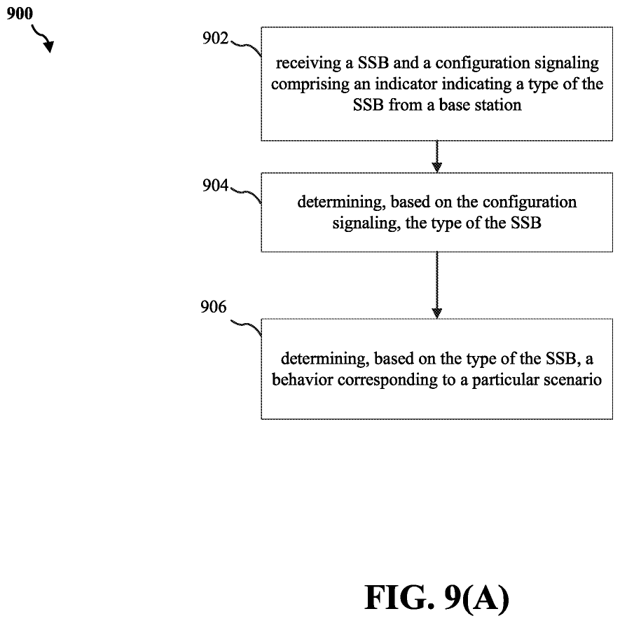

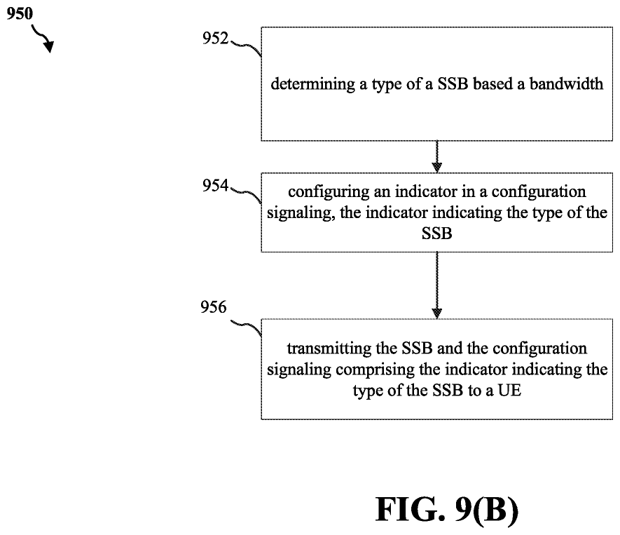

FIG. 9(A) illustrates a flow chart 900 of a process for handling different SSB types at the UE side. This process involves interactions between a network (NW) and a UE (e.g., the UE 704) through a base station (e.g., the base station 702).

At block 902, the UE 704 receives a SSB and a configuration signaling comprising an indicator indicating a type of the SSB from a base station 702. This indicator may optimize the communication process, as it defines the instructions that the UE 704 used for in its measurement or handover tasks. In some embodiments, the configuration signaling may include a measurement object or a handover parameter.

At block 904, the UE determines, based on the indication of the configuration signaling, the type of the received SSB. The SSB type, for example, is a full SSB or a truncated SSB. In some embodiments, the configuration signaling may include a list of carrier frequencies of NR carriers with a truncated PBCH. In such a case, if the UE 704 does not support the Global Synchronization Channel Number (GSCN) value associated with a neighboring carrier frequency, it may choose to ignore the corresponding neighboring cell. Furthermore, the configuration signaling may indicate the NR carriers to be measured during the RRC_IDLE or RRC INACTIVE state for the cell(s) supporting the full SSB or truncated SSB transmission configuration. The configuration signaling may also indicate the NR carriers for reselection measurement reporting for the cell(s) supporting the full SSB or truncated SSB transmission configuration.

Following the determination of the SSB type, at block 906, the UE 704 determines, based on the determined SSB type, a behavior corresponding to a particular scenario. The particular scenario may involve performing measurement or handover tasks.

For example, the particular scenario may include an active cell transmission scenario. Furthermore, the active cell transmission scenario may include a scenario performing a measurement for a serving cell. In this particular scenario, the behavior of the UE 704 may include various measurement instances, including but not limited to L1-RSRP, L3-RSRP, RSRQ, and SINR.

Alternatively, the particular scenario may also include a scenario performing SBI reading, a scenario conducting a RRM measurement, or a scenario re-selecting to a target cell, which correspond to different behaviors of the UE 704. For example, during the RRM measurement, the UE 704 may skip decoding a PBCH in a specific cell on a list of cells where the PBCH is truncated.

The behaviors of the UE 704 in response to the particular scenario depend on the type of the SSB. For example, if the SSB is of the truncated type, the UE 704 may perform an operation within a first evaluation period. Conversely, if the SSB is of the full type, the same operation may be performed by the UE 704 within a second evaluation period. Notably, the first evaluation period is longer than the second evaluation period. That is, compared to the second evaluation period, more SSBs are included in the first evaluation period. Furthermore, if the SSB is of the truncated type, the UE 704 may use multiple truncated SSBs to perform the operation corresponding to the particular scenario.

In some embodiments, the UE 704 may use a soft-combining decoder to decode the truncated SSB. One example of soft combining techniques may be LLR.

FIG. 9(B) illustrates a flow chart 950 of a process for handling different SSB types at the NW side. At block 952, the NW determines a type of a SSB based a bandwidth. That is, if the bandwidth is sufficient, a full SSB can be utilized. On the other hand, if the bandwidth is limited, a truncated SSB will be employed.

Then, at block 954, the NW configures an indicator in a configuration signaling, the indicator indicating the type of the SSB. The type of the SSB may include a truncated SSB or a full SSB. The truncated SSB may include a truncated PBCH occupying fewer than 20 PRBs. The NW may also configures a list of cells where a PBCH is truncated.

In some embodiments, the configuration signaling may include at least one of a measurement object signaling, a handover command, or a RRC signaling. The configuration signaling may also include a list of carrier frequencies of NR carriers with a truncated PBCH.

Finally, at block 956, the NW transmits the SSB and the configuration signaling comprising the indicator indicating the type of the SSB to the UE 704.

Furthermore, the NW may configure the UE 704 to not decode the PBCH during RRM measurements for cells with a truncated PBCH, and configure the UE 704 to decode only a PSS and a SSS for the cells with the truncated PBCH during the RRM measurements.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving a synchronization signal block (SSB) and a configuration signaling comprising an indicator indicating a type of the SSB from a base station;
determining, based on the configuration signaling, the type of the SSB; and
determining, based on the type of the SSB, a behavior corresponding to a particular scenario.

2. The method of claim 1, wherein the particular scenario comprises an active cell transmission scenario.

3. The method of claim 2, wherein the active cell transmission scenario comprises a scenario performing a measurement for a serving cell.

4. The method of claim 3, wherein the measurement comprises a measurement of L1-reference signal receiving power (RSRP), a measurement of L3-RSRP, a measurement of reference signal receiving quality (RSRQ), or a measurement of signal-to-interference-plus-noise ratio (SINR).

5. The method of claim 1, wherein the particular scenario comprises a scenario performing SSB block index (SBI) reading.

6. The method of claim 1, wherein the particular scenario comprises a scenario during handover to a cell.

7. The method of claim 1, wherein the particular scenario comprises a scenario conducting a radio resource management (RRM) measurement.

8. The method of claim 1, wherein the particular scenario comprises a scenario re-selecting to a target cell.

9. The method of claim 1, wherein the type of the SSB comprises a full SSB and a truncated SSB.

10. The method of claim 9, wherein the configuration signaling comprises a list of carrier frequencies of New radio (NR) carriers with a truncated physical broadcast channel (PBCH).

11. The method of claim 9, wherein the behavior comprises:
when the type of the SSB is the truncated SSB, performing an operation corresponding to the particular scenario within a first evaluation period;
when the type of the SSB is the full SSB, performing a same operation within a second evaluation period; and
the first evaluation period is longer than the second evaluation period.

12. The method of claim 11, wherein compared to the second evaluation period, more synchronization signal blocks are comprised in the first evaluation period.

13. The method of claim 9, wherein the behavior comprises:
when the type of the SSB is the truncated SSB, using multiple truncated synchronization signal blocks to perform an operation corresponding to the particular scenario.

14. The method of claim 9, wherein the UE uses a soft-combining decoder to decode the truncated SSB.

15. The method of claim 14, wherein the soft-combining comprises a log-likelihood ratio (LLR).

16. The method of claim 1, wherein during a radio resource management (RRM) measurement, the UE skips decoding a physical broadcast channel (PBCH) in a specific cell on a list of cells where the PBCH is truncated.

17. The method of claim 1, wherein the configuration signaling comprises a measurement object or a handover parameter.

18. A method of wireless communication of a network, comprising:
determining a type of a synchronization signal block (SSB) based on a bandwidth;
configuring an indicator in a configuration signaling, the indicator indicating the type of the SSB; and
transmitting the SSB and the configuration signaling comprising the indicator indicating the type of the SSB to a user equipment (UE).

19. The method of claim 18, wherein the configuration signaling comprises a list of carrier frequencies of New radio (NR) carriers with a truncated physical broadcast channel (PBCH).

20. The method of claim 18, wherein the configuration signaling comprises at least one of a measurement object (MO) signaling, a handover command, or a radio resource control (RRC) signaling.

21. The method of claim 18, wherein the type of the SSB comprises a truncated SSB or a full SSB.

22. The method of claim 21, wherein the network configures a list of cells where a physical broadcast channel (PBCH) is truncated.

23. The method of claim 21, wherein the truncated SSB comprises a truncated physical broadcast channel (PBCH) occupying fewer than 20 physical resource blocks (PRBs).

24. The method of claim 18, further comprising:
configuring the UE to not decode the PBCH during radio resource management (RRM) measurements for cells with a truncated PBCH.

25. The method of claim 24, further comprising:
configuring the UE to decode only a primary synchronization signal (PSS) and a secondary synchronization signal (SSS) for the cells with the truncated PBCH during the RRM measurements.

26. An apparatus for wireless communication, the apparatus being a user equipment (UE), comprising:
a memory; and
at least one processor coupled to the memory and configured to:
receive a synchronization signal block (SSB) and a configuration signaling comprising an indicator indicating a type of the SSB from a base station;
determine, based on the configuration signaling, the type of the SSB; and
determine, based on the type of the SSB, a behavior corresponding to a particular scenario.
